(19) United States
(12) Patent Application Publication
(10) Pub. No.: US 2024/0430155 A1
(43) Pub. Date: Dec. 26, 2024

(54) TARGET ENVIRONMENT AGNOSTIC NETWORK FUNCTION DEPLOYMENT PIPELINE

(71) Applicant: DISH Wireless L.L.C., Englewood, CO (US)

(72) Inventor: Sundeep Goswami, Leesburg, VA (US)

(21) Appl. No.: 18/390,781

(22) Filed: Dec. 20, 2023

Related U.S. Application Data
(60) Provisional application No. 63/522,627, filed on Jun. 22, 2023.

(51) Int. Cl. H04L 41/0803; H04L 41/084

(52) U.S. Cl. CPC H04L 41/0803; H04L 41/0843

(57) ABSTRACT

A system for deploying network functions into target cloud environments in a cellular telecommunication network is cloud computing service provider agnostic. The system may use target environment agnostic GUIs to collect network function and IP address information for the deployment of the network function. The system populates a template for deploying the network function based on the network function and IP address information as well as the identity of the target environment. The system builds and deploys the network functions in the target environment based on the template.

### BRIEF SUMMARY

In various embodiments, a plurality of cellular telecommunication network components, including various network functions, may have configurations that need to be updated as part of the operation of the network and also as the network changes (e.g., as network components are added or removed). However, such network components may be maintained, supported and/or provided by various different vendors or manufacturers of network equipment which may use different file formats and methods of defining and identifying network component parameters. Thus, it is advantageous to have efficient techniques and processes as described herein for updating configuration of cellular telecommunication network components in a cellular telecommunication network. It is with respect to these and other considerations that the embodiments described herein have been made.

Fifth-generation wireless (5G) technology provides a broad range of wireless services delivered to the end user across multiple access platforms and multi-layer networks. 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible and virtualized RAN with interfaces creating additional data access points.

5G network functions may be completely software-based and designed as cloud-native, meaning that they're agnostic to the underlying cloud infrastructure, allowing higher deployment, agility and flexibility. With the advent of 5G, industry experts defined how the 5G core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations.

Multi-Access Edge Computing (MEC) is an important element of 5G architecture. MEC is an evolution in cloud computing that brings the applications from centralized data centers to the network edge, and therefore closer to the end users and their devices. This essentially creates a shortcut in content delivery between the user and host, and the long network path that once separated them.

This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better supports the high volume of connected devices inherent to 5G deployment and the rise of loT.

The 3rd Generation Partnership Project (3GPP) develops protocols for mobile telecommunications and has developed a standard for 5G. The 5G architecture is based on what is called a Service-Based Architecture (SBA), which implements IT network principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the operator faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open source development, ultimately to ease the deployment of new features and technology with scale. The O-RAN alliance objective is to allow multi-vendor RAN deployment with off-the shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for loT applications where the number of devices is in the millions.

The 5G New Radio (5G NR) RAN comprises of a set of radio base stations (each known as Next Generation Node B (gNb)) connected to the 5G core (5GC) and to each other. The gNb incorporates three main functional modules: the Centralized Unit (CU), the distributed Unit (DU), and the Radio Unit (RU), which can be deployed in multiple combinations. The primary interface is referred to as the F1 interface between DU and CU and are interoperable across vendors. The CU may be further disaggregated into the CU user plane (CU-UP) and CU control plane (CU-CP), both of which connect to the DU over F1-U and F1-C interfaces respectively. This 5G RAN architecture is described in 3GPP TS 38.401 V16.8.0 (2021-12). Extending the virtualization and decoupling of network functions in 5G, each network function (NF) is formed by a combination of small pieces of software code called as microservices.

Embodiments, described herein may use containerization to implement such microservices and network functions, referred to as containerized network functions (CNFs). Containerization is the packaging of software code with just the operating system (OS) libraries and dependencies required to run the code to create a single lightweight executable (a container) that runs consistently on any infrastructure. Software platforms, such as Kubernetes, manage containerized workloads and automate the deployment, scaling, and management of containerized applications. Compared to virtual machines (VMs) containers can share the Operating System (OS) among the applications since each application runs within its own container. Therefore, containers are considered lightweight. A container has its own file system, share of CPU, memory and processor space. As they are decoupled from the underlying infrastructure, they are portable across clouds and OS distributions. As disclosed herein, Such CNFs of the 5G NR cellular telecommunication network may be hosted on a cloud service provider cloud and referred to herein as cloud-native network functions.

Briefly described, embodiments disclosed herein are directed to a system for deploying network functions into target cloud environments for a cellular telecommunication network in a cloud computing service provider agnostic manner (i.e., inputs provided by network function designers and IP planners can be universally applied to deploy a network function in any number of target environments). In an example embodiment, the system may use target environment agnostic GUIs to collect network function and IP address information for the deployment of the network function. The system populates a template for deploying the network function based on the network function and IP address information as well as the identity of the target environment. The system builds and deploys the network functions in the target environment based on the template and may monitor the network functions for inadvertent changes or changes to the template.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a diagram of an example system architecture overview of a cellular telecommunication network for which deploying network functions into target cloud computing environments may be performed in accordance with embodiments described herein.

FIG. 2 is a block diagram of a system for deploying NFs into target cloud computing environments in accordance with embodiments described herein.

FIG. 3 is a block diagram of an example cloud computing service provider cloud in which the target network functions are implemented in accordance with embodiments described herein.

FIG. 4 illustrates a logical flow diagram showing an example embodiment of a process for deploying network functions into target cloud computing environments for a cellular telecommunication network in accordance with embodiments described herein.

FIG. 5 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems, networks and databases, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

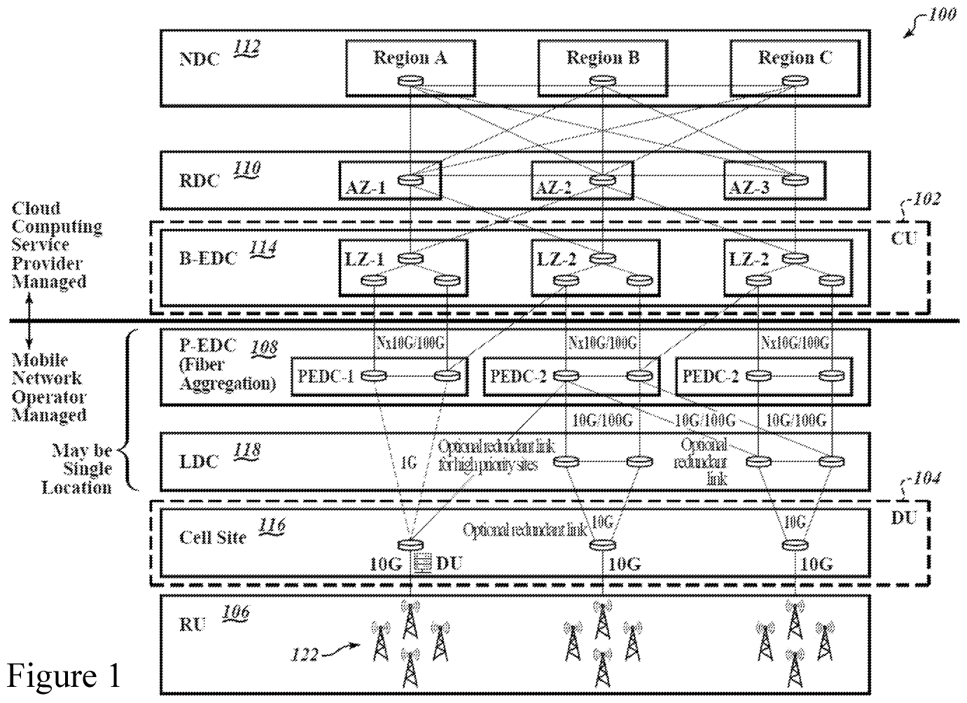

FIG. 1 illustrates a diagram of an example system architecture overview of a cellular telecommunication network 100 for which deploying network functions (NF) into target cloud computing environments may be performed in accordance with embodiments described herein.

The cellular telecommunication network 100 illustrates an example architecture of at least one wireless network of a mobile network operator (MNO) that is operated and/or controlled by the MNO. The system may comprise a 5G wireless cellular telecommunication network including a disaggregated, flexible and virtual RAN with interfaces creating additional data access points and that is not constrained by base station proximity or complex infrastructure. As shown in FIG. 1, a 5G RAN is split into DUs (e.g., DU 104) that manage scheduling of all the users and a CU 102 that manages the mobility and radio resource control (RRC) state for all the UEs. The RRC is a layer within the 5G NR protocol stack.

The CU 102 is hosted within one or more edge data centers, for example-local zones, of the cloud computing service provider. For example, local zone 1 (LZ-1) 124. A local zone is a type of infrastructure deployment of the cloud computing service provider that places compute, storage, database, and/or other select cloud computing services closer to end users of the services and systems hosted by cloud computing service provider (e.g., closer to large population and industry centers). Local zones enable users of the cloud computing service provider cloud to use select cloud computing services, like compute and storage services, closer to more end-users, providing them very low latency access to the applications running locally. Local Zones are also connected to the parent region (e.g., Region

A, Region B and/or Region C shown in FIG. 1) via the cloud service provider's redundant and very high bandwidth private network, giving applications running in local zones fast, secure, and seamless access to the rest of the cloud computing services.

As shown in FIG. 1, the radio unit (RU) 106 converts radio signals sent to and from the antenna of base stations 122 (also referred to as base transceiver stations (BTS)) into a digital signal for transmission over packet networks. It handles the digital front end (DFE) and the lower physical (PHY) layer, as well as the digital beamforming functionality.

The DU 104 may sit close to the RU 106 and runs the radio link control (RLC), the Medium Access Control (MAC) sublayer of the 5G NR protocol stack, and parts of the PHY layer. The MAC sublayer interfaces to the RLC sublayer from above and to the PHY layer from below. The MAC sublayer maps information between logical and transport channels. Logical channels are about the type of information carried whereas transport channels are about how such information is carried. This logical node includes a subset of the gNb functions, depending on the functional split option, and its operation is controlled by the CU 102.

The CU 102 is the centralized unit that runs the RRC and Packet Data Convergence Protocol (PDCP) layers. A gNb may comprise a CU and one DU connected to the CU via Fs-C and Fs-U interfaces for control plane (CP) and user plane (UP) respectively. A CU with multiple DUs will support multiple gNbs. The split architecture enables a 5G network to utilize different distribution of protocol stacks between CU 102 and DU 104 depending on mid-haul availability and network design. The CU 102 is a logical node that includes the gNb functions like transfer of user data, mobility control, RAN sharing, positioning, session management etc., with the exception of functions that may be allocated exclusively to the DU 104. The CU 102 controls the operation of several DUs 104 over the mid-haul interface.

As mentioned above, 5G network functionality is split into two functional units: the DU 104, responsible for real time 5G layer 1 (L1) and 5G layer 2 (L2) scheduling functions, and the CU 102 responsible for non-real time, higher L2 and 5G layer 3 (L3). As shown in FIG. 1, the DU's server and relevant software may be hosted on a cellular (cell) site 116 itself or can be hosted in an edge cloud (local data center (LDC) 118 or central office) depending on transport availability and fronthaul interface. DUs from multiple cell sites may be pooled and co-located at one LDC 118. The CU's server and relevant software may be hosted in a regional cloud data center or, as shown in FIG. 1, in a breakout edge data center (B-EDC) 114. As shown in FIG. 1, the DU 104 may be provisioned to communicate via a pass-through edge data center (P-EDC) 108. The P-EDC 108 may provide a direct circuit fiber connection from the DU directly to the primary physical data center (e.g., B-EDC 114) hosting the CU 102. In some embodiments, the LDC 118, P-EDC 108 and/or the B-EDC 114 may be co-located or in a single location. The CU 102 may be connected to a regional cloud data center (RDC) 110, which in turn may be connected to a national cloud data center (NDC) 112. In the example embodiment, the P-EDC 108, the LDC 118, the cell site 116 and the RU 106 may all be managed and/or controlled by the mobile network operator and the B-EDC 114, the RDC 110 and the NDC 112 may all be managed and/or hosted by a cloud computing service provider. In some embodiments, the P-EDC 108, LDC 118 and cell site 116 may be at a single location or facility (e.g., a colocation data center). In other embodiments, the B-EDC 114, the P-EDC 108, the LDC 118 and cell site 116 may be at a single location or facility (e.g., a colocation data center). According to various embodiments, the actual split between DU and RU may be different depending on the specific use-case and implementation.

In various embodiments, cellular telecommunication network functions, such as those described above and others, may be moved between various cloud computing service provider's cloud platforms or additional network functions may be added to cloud platforms (e.g., for cost, performance, high availability, etc.). However, moving network functions or deploying new network functions to different cloud computing service provider's cloud platforms may require the use of different file formats and methods of defining network component parameters. Thus, it is advantageous to have efficient techniques and processes as described herein for deploying NFs into target cloud computing environments in a cellular telecommunication network, such as cellular telecommunication network 100.

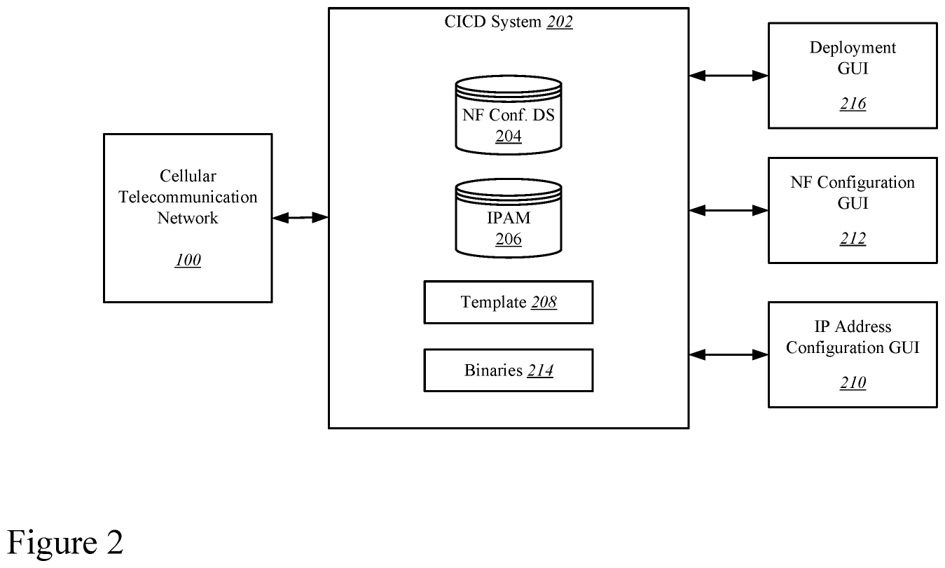

FIG. 2 is a block diagram of a system 200 for deploying NFs into target cloud computing environments in accordance with embodiments described herein.

The system 200 of FIG. 2 comprises a continuous integration and continuous delivery (CICD) system 202 that includes various graphical user interfaces (GUIs) for management of network functions in cellular telecommunication network 100. In an example embodiment, the CICD system 202 may include a NF configuration GUI 212, an IP address configuration GUI 210, and a deployment GUI 216. The GUIs provide an interface for network engineers to provide information for deployment of NFs in a way that is agnostic of the cloud computing environment to which the NFs will be deployed.

For example, the NF configuration GUI 212 may be a portal through which a network function designer (i.e., an engineer who understands packet core, radio layer, etc.) may input the network function configuration requirements for the NF to be deployed. As the network function designer enters the network function configuration requirements into the NF configuration GUI, the requirements may be stored in a NF configuration datastore 204 of the CICD system 202. In one embodiment, the network requirements may be stored in NF configuration datastore 204 as key-value pairs to provide flexibility and extensibility of the NF configuration datastore 204.

Similarly, the IP address configuration GUI 210 may be a portal through which an IP planner (i.e., an engineer who plans how IP connectivity with the rest of the cellular telecommunication network 100 will happen) can input IP addresses and other connectivity information. IP address assignment information provided by the IP planner may be stored in an IP address management (IPAM), or IPAM-like, instance in the CICD system 202. The IPAM 206 provides IP address assignments for each NF deployment.

The deployment GUI 216 may provide an interface for a network deployment engineer to deploy NFs by providing a target NF name and a target environment (e.g., a specific cloud computing service provider cloud) to which the NF is to be deployed. In response to receiving the target NF name and target environment via the deployment GUI 216, the CICD system 202 triggers a script to create a NF package for deploying the NF to the target environment. To create the

NF package, the script parses the NF specific parameters and attribute settings from the NF configuration datastore and populates corresponding sections of a template 208 with those values while similarly populating networking sections of the template 208 with IP address assignments from IPAM 206. In some embodiments, the template comprises a Kubernetes umbrella Helm chart and

YAML files. Because the template 208 is designed for use in deploying NFs to the clouds of multiple different cloud computing service providers, the template 208 includes information that may not be necessary or is required in a different format for deploying the selected NF to the target environment. To address this issue, the script masks the portions of the template that are not relevant to the target environment (e.g., inserts comment markers into the template so the deployment function ignores those portions). Once the template 208 has been updated with the information from the NF configuration datastore 204 and IPAM 206, the script triggers a NF package build using binaries 214 and template 208. The resulting in a NF package that is ready for deployment to the target environment.

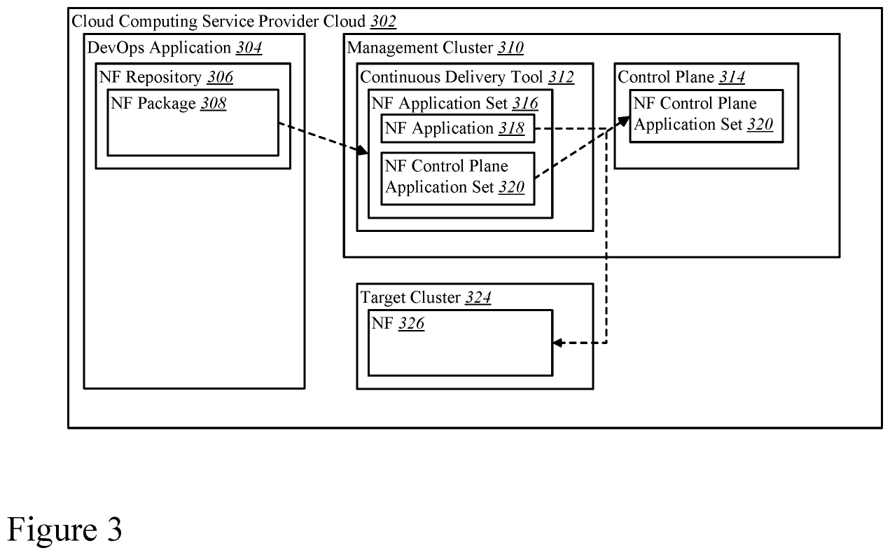

Referring now to FIG. 3, an example cloud computing service provider cloud 302 in which the target environment is implemented is shown. The cloud 302 includes a DevOps application 304, management cluster 310, and target cluster 324. When a NF package 308 has been created for a new NF deployment, the CICD system 202 checks the NF package 308 into an NF repository 306 of the DevOps application 304. In one embodiment, the DevOps application is a GitLab platform and code repository.

In one embodiment, management cluster 310 is a Kubernetes cluster that includes a continuous delivery tool 312 and a control plane 314. In one embodiment, the continuous delivery tool 312 is a continuous delivery tool, such as ArgoCD, which follows the GitOps pattern of using Git repositories (e.g., NF repository 306) as the source of truth for the NF deployments in cloud 302. In one embodiment, control plane 314 is a Kubernetes control plane add-on, such as Crossplane, that creates a universal control plane for deploying infrastructure in a cloud environment.

In response to NF package 308 being checked into NF repository 306, continuous delivery tool 312 ingests NF application set 316 and triggers a code pipeline for an infrastructure build to create target cluster 324 for NF 326. In addition, a NF application set 316, including NF application 318 and NF control plane application set 320, from NF package 308 is created by continuous delivery tool 312 and NF 326 is deployed in target cluster 324. The creation of the application set 316 triggers the continuous delivery tool to deploy the components of the NF onto the target cluster 324. In addition, the continuous delivery tool maintains the NF in its declared stated, that is defined in the application set 316, to ensure there are no changes to the NF desired configuration through manual intervention or faults and errors at the infrastructure layer.

In various embodiments, continuous delivery tool 312 monitors the states of the NF 326 in target cluster 324 for any deviations from the attributes for the NF in the NF repository 306 and, responsive to detecting a deviation, reconciles the NF 326 with the attributes in the NF repository 306. This continuous monitoring ensures that any changes made inadvertently to the NF 326 in target cluster 324 are reverted to the declared implementation. Further, any changes that are made by the network function designer or IP planner are propagated by the continuous delivery tool 312 to the NF 326 in target cluster 324.

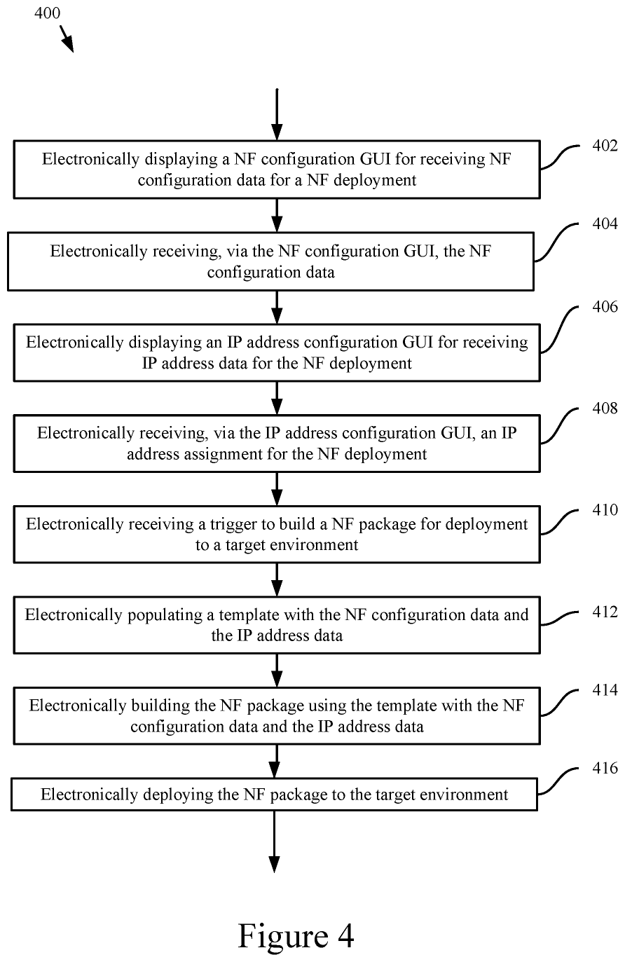

FIG. 4 illustrates a logical flow diagram 400 showing an example embodiment of a process for deploying network functions into target cloud computing environments in a cellular telecommunication network in accordance with embodiments described herein.

At 402, CICD system 202 electronically displays a NF configuration GUI 212 for receiving NF configuration data for a NF deployment. In one embodiment, the NF configuration GUI 212 may include fields into which a network function designer may enter network function configuration data. The fields for the network function configuration data are deployment environment agnostic, in some embodiments.

At 404, CICD system 202 electronically receives, via the NF configuration GUI 212, the NF configuration data.

At 406, CICD system 202 electronically displays an IP address configuration GUI 210 for receiving IP address data for the NF deployment. In one embodiment, the IP address configuration GUI 210 may include fields into which an IP planner may enter site specific IP details.

At 408, CICD system 202 electronically receives, via the IP address configuration GUI 210, IP address assignments for the NF deployment. In some embodiments, the IP planner and the network function designer may respectively enter information into the IP address data screen and NF configuration data screen asynchronously.

At 410, CICD system 202 electronically receives, via deployment GUI 216, a trigger to build a NF package for deployment to a target environment. In one embodiment, a deployment engineer selects a network function and a target environment (e.g., a cloud computing service provider and cloud location) for the NF deployment via the deployment GUI 216 to trigger the NF package build. At 412, CICD system 202 electronically populates a template with the NF configuration data and the IP address data. In one embodiment, to populate the template with the NF configuration data and the IP address data, the CICD system 202 parses the NF configuration data based on the target environment to identify relevant NF configuration data for the target environment, populates the relevant portions of the template with the relevant NF configuration data for the target environment, and masks the remaining portions of the template.

At 414, CICD system 202 electronically builds the NF package using the template with the NF configuration data and the IP address data.

At 416, CICD system 202 electronically deploys the NF package to the target environment. In one embodiment, to deploy the NF package to the target environment, CICD system 202 checks the NF package into a DevOps repository in the target environment.

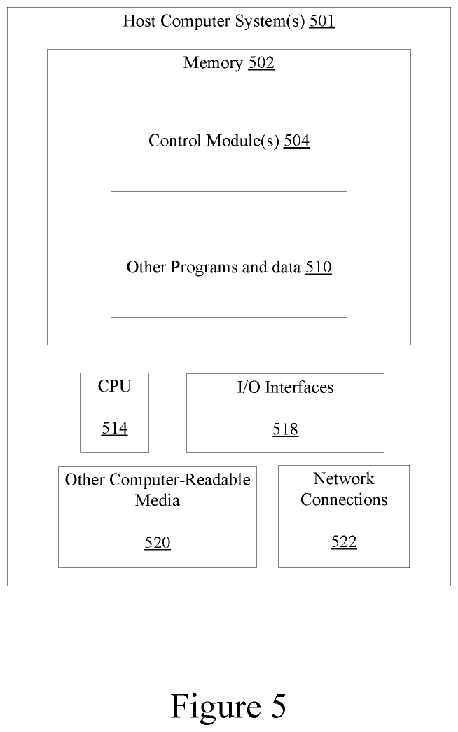

FIG. 5 shows a system diagram that describes an example implementation of a computing system(s) for implementing embodiments described herein.

The functionality described herein deploying network functions into target cloud computing environments in a cellular telecommunication network can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 5 illustrates an example of underlying hardware on which such software and functionality may be hosted and/or implemented.

In particular, shown is example host computer system(s) 501. For example, such computer system(s) 501 may represent one or more of those in various data centers, base stations and cell sites shown and/or described herein that are, or that host or implement the functions of: CICD system 202, routers, components, microservices, nodes, node groups, control planes, clusters, virtual machines, NFs, and other aspects described herein for updating configuration of cellular telecommunication network components. In some embodiments, one or more special-purpose computing systems may be used to implement the functionality described herein. Accordingly, various embodiments described herein may be implemented in software, hardware, firmware, or in some combination thereof. Host computer system(s) 501 may include memory 502, one or more central processing units (CPUs) 914, I/O interfaces 518, other computer-readable media 520, and network connections 522.

Memory 502 may include one or more various types of non-volatile and/or volatile storage technologies. Examples of memory 502 may include, but are not limited to, flash memory, hard disk drives, optical drives, solid-state drives, various types of random-access memory (RAM), various types of read-only memory (ROM), neural networks, other computer-readable storage media (also referred to as processor-readable storage media), or the like, or any combination thereof. Memory 502 may be utilized to store information, including computer-readable instructions that are utilized by CPU 514 to perform actions, including those of embodiments described herein.

Memory 502 may have stored thereon control module(s) 504. The control module(s) 504 may be configured to implement and/or perform some or all of the functions of the systems, components and modules described herein for updating configuration of cellular telecommunication network components. Memory 502 may also store other programs and data 510, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 522 are configured to communicate with other computing devices to facilitate the functionality described herein. In various embodiments, the network connections 522 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 518 may include video interfaces, other data input or output interfaces, or the like. Other computer-readable media 520 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for deploying network functions (NF) into target cloud computing environments in a cellular telecommunication network, the method comprising:
electronically displaying a NF configuration graphical user interface (GUI) for receiving NF configuration data for a NF deployment;
electronically receiving, via the NF configuration GUI, the NF configuration data;
electronically displaying an IP address configuration GUI for receiving IP address data for the NF deployment;
electronically receiving, via the IP address configuration GUI, an IP address assignments for the NF deployment;
electronically receiving a trigger to build a NF package for deployment to a target environment;
electronically populating a template with the NF configuration data and the IP address data;
electronically building the NF package using the template with the NF configuration data and the IP address data; and
electronically deploying the NF package to the target environment.

2. The method of claim 1, wherein the NF configuration data and the IP address data are provided independent of the target environment and populating the template with the NF configuration data and the IP address data includes:
electronically parsing the NF configuration data based on the target environment to identify relevant NF configuration data for the target environment;
electronically populating relevant portions of the template with the relevant NF configuration data for the target environment; and
electronically masking remaining portions of the template.

3. The method of claim 1, wherein the template includes Kubernetes Helm charts YAML files.

4. The method of claim 1, further comprising:
electronically storing the NF configuration data in a NF configuration data store as a key-value pair.

5. The method of claim 1, further comprising:
electronically storing the IP address data in an IP Address Management (IPAM) instance.

6. The method of claim 1, wherein deploying the NF package to the target environment includes:
creating a target cluster in the target environment;
deploying the NF package to the target cluster; and
validating the NF package in the target cluster.

7. The method of claim 1, further comprising:
monitoring the NF package in the target environment for a deviation from the template; and
responsive to detecting the deviation, reconciling the NF package with template.

8. A system for deploying network functions (NFs) into target environments in a cellular telecommunication network, the system comprising:
at least one memory that stores computer executable instructions; and
at least one processor that executes the computer executable instructions to cause actions to be performed, the actions including:
electronically displaying a NF configuration graphical user interface (GUI) for receiving NF configuration data for a NF deployment;
electronically receiving, via the NF configuration GUI, the NF configuration data;
electronically displaying an IP address configuration GUI for receiving IP address data for the NF deployment;
electronically receiving, via the IP address configuration GUI, an IP address assignments for the NF deployment;
electronically receiving a trigger to build a NF package for deployment to a target environment;
electronically populating a template with the NF configuration data and the IP address data;
electronically building the NF package using the template with the NF configuration data and the IP address data; and
electronically deploying the NF package to the target environment.

9. The system of claim 8, wherein the NF configuration data and the IP address data are provided independent of the target environment and populating the template with the NF configuration data and the IP address data includes:
electronically parsing the NF configuration data based on the target environment to identify relevant NF configuration data for the target environment;
electronically populating relevant portions of the template with the relevant NF configuration data for the target environment; and
electronically masking remaining portions of the template.

10. The system of claim 8 wherein the template includes Kubernetes Helm charts YAML files.

11. The system of claim 8 wherein the actions further include:
electronically storing the NF configuration data in a NF configuration data store as a key-value pair.

12. The system of claim 8 wherein the actions further include:
electronically storing the IP address data in an IP Address Management (IPAM) instance.

13. The system of claim 8, wherein deploying the NF package to the target environment includes:
creating a target cluster in the target environment;
deploying the NF package to the target cluster; and
validating the NF package in the target cluster.

14. The system of claim 8 wherein the actions further include:
monitoring the NF package in the target environment for a deviation from the template; and
responsive to detecting the deviation, reconciling the NF package with template.

15. A non-transitory computer-readable storage medium having computer-executable instructions stored thereon that, when executed by at least one processor, cause the at least one processor to cause actions to be performed, the actions including:
electronically displaying, by a system for deploying network functions (NFs) into target environments in a cellular telecommunication network, a NF configuration graphical user interface (GUI) for receiving NF configuration data for a NF deployment;
electronically receiving, via the NF configuration GUI, the NF configuration data;
electronically displaying an IP address configuration GUI for receiving IP address data for the NF deployment;
electronically receiving, via the IP address configuration GUI, an IP address assignments for the NF deployment;
electronically receiving a trigger to build a NF package for deployment to a target environment;
electronically populating a template with the NF configuration data and the IP address data;
electronically building the NF package using the template with the NF configuration data and the IP address data; and
electronically deploying the NF package to the target environment.

16. The non-transitory computer-readable storage medium of claim 15, wherein the NF configuration data and the IP address data are provided independent of the target environment and populating the template with the NF configuration data and the IP address data includes:
electronically parsing the NF configuration data based on the target environment to identify relevant NF configuration data for the target environment;
electronically populating relevant portions of the template with the relevant NF configuration data for the target environment; and
electronically masking remaining portions of the template.

17. The non-transitory computer-readable storage medium of claim 15 wherein the actions further include:
electronically storing the NF configuration data in a NF configuration data store as a key-value pair.

18. The non-transitory computer-readable storage medium of claim 15 wherein the actions further include:
electronically storing the IP address data in an IP Address Management (IPAM) instance.

19. The non-transitory computer-readable storage medium of claim 15, wherein deploying the NF package to the target environment includes:
creating a target cluster in the target environment;
deploying the NF package to the target cluster; and
validating the NF package in the target cluster.

20. The non-transitory computer-readable storage medium of claim 15 wherein the actions further include:
monitoring the NF package in the target environment for a deviation from the template; and
responsive to detecting the deviation, reconciling the NF package with template.
